(19) United States
(12) Patent Application Publication
(10) Pub. No.: US 2024/0147954 A1
(43) Pub. Date: May 9, 2024

(54) RETROFIT FLUSH MOUNT AIR SIDEWALL INLET

(71) Applicant: Double L Group, LLC, Dyersville, IA (US)

(72) Inventors: Elizabeth BEELER, Baldwin, IA (US); Dick STREICHER, Farmersburg, IA (US)

(21) Appl. No.: 18/499,025

(22) Filed: Oct. 31, 2023

Related U.S. Application Data
(60) Provisional application No. 63/422,322, filed on Nov. 3, 2022.

(51) Int. Cl. A01K 1/00; F24F 13/14

(52) U.S. Cl. CPC A01K 1/0064; F24F 13/14

(57) ABSTRACT

A sidewall inlet that assists in bringing fresh air into the interior room of a building. The inlet housing provides an opening to the interior room of a building through a rough opening, with the housing having a design to mount flush to the interior sidewall of the room and covering many size variations of rough openings. The housing of the inlet consisting of a frame assembly and a blade assembly that allows the inlet to be constructed to fit various lengths of rough openings and provide the proper air mixture needed in a building. The inlet having a moveable blade is pivotally mounted with a continuous hinge and a seal on the top frame to minimize air leakage when the inlet is closed. The housing is designed in such a way to provide optimal air mixture and to maximize airflow during ventilation.

This application claims priority to Provisional U.S. Patent Application 63/422,322 filed Nov. 3, 2022, the entirety of which is incorporated by reference herein.

### BACKGROUND OF THE INVENTION

Buildings used to raise poultry and livestock utilize ventilation and movement or flow of air to promote desirable interior conditions. Air is a mixture of water vapor, carbon dioxide, oxygen, nitrogen, and other gases. In buildings used to raise poultry and livestock, there are by-products of poultry and livestock production which include heat, water, carbon dioxide, and droppings. All of these by-products are exhausted into the building (i.e. “house”). Dust particles from those by-products become airborne from daily bird movement and microorganisms may be attached to those dust particles. Those microorganisms can be a dwelling place for pathogenic bacteria and viruses, which directly affect bird health and productivity. A flooring consisting of litter 4 to 18 inches deep is standard inside these poultry houses. Litter typically consists of wood shavings, peanut hulls, or any other medium that can absorb moisture and excrement from the poultry and livestock inside the facility. Ventilation management of the interior of these buildings is necessary to control the temperature, relative humidity, microorganism levels, house uniformity, and other gases within the facilities to promote ideal house conditions and profitability. When facilities are not ventilated properly, the litter absorbs more moisture which results in an increase of microorganism and bacterial levels on the floor of the facility.

Livestock building and poultry house designs continue to be modified, which leads to improvements being made to these facilities over time. Designs of poultry houses are known to those skilled in the art. An original poultry house design is approximately 40 feet wide by 500 feet long. For new house construction, a standard house size is approximately 60 feet wide by 600 feet long. The overall width of the new facilities has increased as much as 50% from recent years. The concept of ventilation management, however, has continued to be based on the original building and house designs. Ventilation Systems include three stages: minimum ventilation, which utilizes ceiling and/or sidewall inlets; transitional ventilation, utilizing sidewall inlets and tunnel doors; and full tunnel ventilation, which uses only tunnel doors.

One problem in new buildings, which are 50% wider, is that the old ventilation technology consists of galvanized inlets, which are not able to maintain proper air mixing. This leads to additional moisture in the litter which results in larger microorganism concentrations. During minimum ventilation with the existing galvanized inlets, air is transferred from the exterior of the building, through a rough opening, to the interior part of the house via galvanized inlet baffles, or doors, which open between ¼ inch to 1 inch the entire length of the door. Air then enters the room through the galvanized inlet and flows around and over the flat baffle, following a straight line directly colliding with the interior ceiling of the house. The air then bounces off the ceiling and is directed immediately towards litter on the floor. Ventilation with these galvanized inlets creates improper air mixing and does not allow the air to mix and heat uniformly. One method used to combat the effect of air bouncing directly off the ceiling, is to open the galvanized inlet baffle far enough to direct the air parallel to the ceiling instead of colliding with the ceiling. When the opening is increased, the total area of the opening from the exterior to the interior is increased, reducing the velocity of the incoming flow of air. In houses that are 50% wider, this reduction in velocity decreases the distance air travels resulting in air not flowing to the center of the house, creating a disproportional mixing of air. Any of the ventilation methods that utilize an existing galvanized sidewall inlet do not promote good temperature uniformity, relative humidity levels, or lower microorganism and bacterial levels.

The maintenance required with the known technology is an ongoing problem with new building construction. To those known in the art, until this point, a standard sidewall inlet offering on the market is a galvanized sidewall inlet. The galvanized inlet housing is constructed of galvanized metal with the inlet consisting of a door, or baffle, that is hinged at the bottom of the inlet. The door of the inlet is typically galvanized metal. To insulate and add R-Value, a foam board or equivalent is glued to the backside of the inlet door. The standard environment inside of the poultry house contains gases that corrode the galvanized inlet over time. The darkling beetles, present in every poultry house, will pupate in the insulation glued on the baffle and over time the insulation is almost completely removed from the inlet. For these reasons, the galvanized inlet design does not promote longevity and must be fully replaced after 5 to 8 years of operation. This replacement maintenance is conducted by utilizing the existing rough openings already framed in the house from the prior inlets and installing new inlets into the exiting rough openings. To those known in the art, when replacing these galvanized inlets and retrofitting the house after 5 to 8 years, the typical inlet installed is recessed into the sidewall rough opening a minimum of ½ inch to 2 inches depending on the standard model. The inlet size must be very precise to fit the existing rough opening since the replacement inlets need to be recessed into the rough opening for installation purposes.

To those known in the art, there can be thousands of variations of rough openings. Current inlets available in the market only offer a few limited standard sizes that fit into a recessed opening. Therefore, there is a need for an improved inlet that will provide a customizable size and easier installation process as well as proper ventilation for moisture and temperature levels to better control microorganism and bacterial levels from proper air mixing in both original and newly constructed houses. Along with providing the purchaser a longer lasting product, the flush mount sidewall inlet installation design does not require a precise fit inside the many variations of rough openings, therefor saving the purchaser and installer time and money.

### SUMMARY OF THE INVENTION

The flush mount sidewall inlet of the invention disclosed herein is customizable for proper fitting over multiple size combinations of rough openings. The housing is flush mounted onto the interior sidewall and does not require fitting into a specified rough opening. The invention is designed with endcaps which allow the inlets top frame, bottom frame, and louver blade to be adjusted to various sizes as needed. Each inlet also has a fully insulated curved louver blade, louver blade endcaps, an adjustable top and bottom frame, and frame endcaps. In a preferred embodiment, the components of the inlet are foam-filled with insulation. The design of the curved louver blade and frames, along with the fully insulated features, allows for better air circulation and temperature control of the building. This allows for better control of microorganism and bacterial levels from uniform air mixing of moisture and temperature levels. The flush mount sidewall inlet may be made of plastic components filled with insulation. Such material increases the longevity of the inlet by eliminating corrosion of the inlet as well as eliminating the darkling beetle's ability to pupate within the insulation, therefore increasing the life of the insulation within the plastic components.

### BRIEF DESCRIPTION OF THE DRAWINGS

FIG. 1 is an exploded perspective view from the back of the flush mount sidewall inlet showing the preferred design and parts of the inlet;

FIG. 2 is a side perspective view of the inlet and frame without the frame endcaps as viewed from the back of the inlet;

FIG. 2A is an enlarged view of FIG. 2 showing the connection of the top frame with the recessed trailing edge of the louver blade and the louver blade end cap, the curved ridge end of the endcap, and showing the weatherstrip groove in the top frame profile;

FIG. 2B is an enlarged view of FIG. 2 which shows the preferred connection of the leading edge of the louver blade to the bottom frame of the inlet using a continuous hinge placed in the hinge grooves as well as showing the left endcap weatherstrip groove;

FIG. 3 is a front view of the flush mount sidewall inlet;

FIG. 4 is a perspective view of the back and top of the top frame;

FIG. 4A is a right-side view of the top frame;

FIG. 4B is an enlarged view of FIG. 4A, showing the weatherstrip groove;

FIG. 5 is a perspective view of the front and bottom of the bottom frame;

FIG. 5A is a right-side view of the bottom frame;

FIG. 5B is an enlarged view of FIG. 5A of the hinge groove;

FIG. 6 is a top perspective view of the hinge;

FIG. 6A is a side view of the hinge;

FIG. 7 is a perspective view as seen from the outside of the right frame endcap;

FIG. 7A is a side view as seen on the inside of a right frame endcap;

FIG. 8 is an exploded perspective view of the blade assembly, the louver blade and louver blade endcaps as it would appear from the back of the inlet;

FIG. 8A is a left side view of the louver blade with no blade endcaps;

FIG. 8B is an enlarged view of FIG. 8, showing the hinge groove on the leading edge of the louver blade;

FIG. 9 is a perspective view of the inside of a left blade endcap;

FIG. 9A is a side view of the outside of a left blade endcap;

FIG. 9B is an enlarged view of FIG. 9A of the weatherstrip groove on the outside of the left blade endcap;

FIG. 10 is a side view of the inside of a right blade endcap;

FIG. 10A is an enlarged view of FIG. 10 showing the curved and recessed area on the trailing edge of the right blade endcap;

FIG. 10B is an enlarged view of FIG. 10 showing the hinge groove on the leading edge of the right blade endcap;

FIG. 11 shows rough openings in a wall;

FIG. 12 shows old technology from the side view and a 3D perspective view in a rough opening of a wall;

FIG. 13 shows a closed flush mount sidewall inlet from a side view and a 3D perspective view over a rough opening of a wall;

FIG. 14 shows an opened flush mount sidewall inlet from a side view and a 3D perspective view over a rough opening of a wall.

### DETAILED DESCRIPTION OF THE PREFERRED EMBODIMENTS OF THE INVENTION

The present invention disclosed herein includes an inlet which may be placed over a rough opening 115, typically on the inside wall of livestock buildings and poultry houses, and thus will be described below chiefly in this context. It will be understood by one skilled in the art that the inlet disclosed herein may be useful in other applications which require inlets to be installed over any rough opening 115 for ventilation purposes.

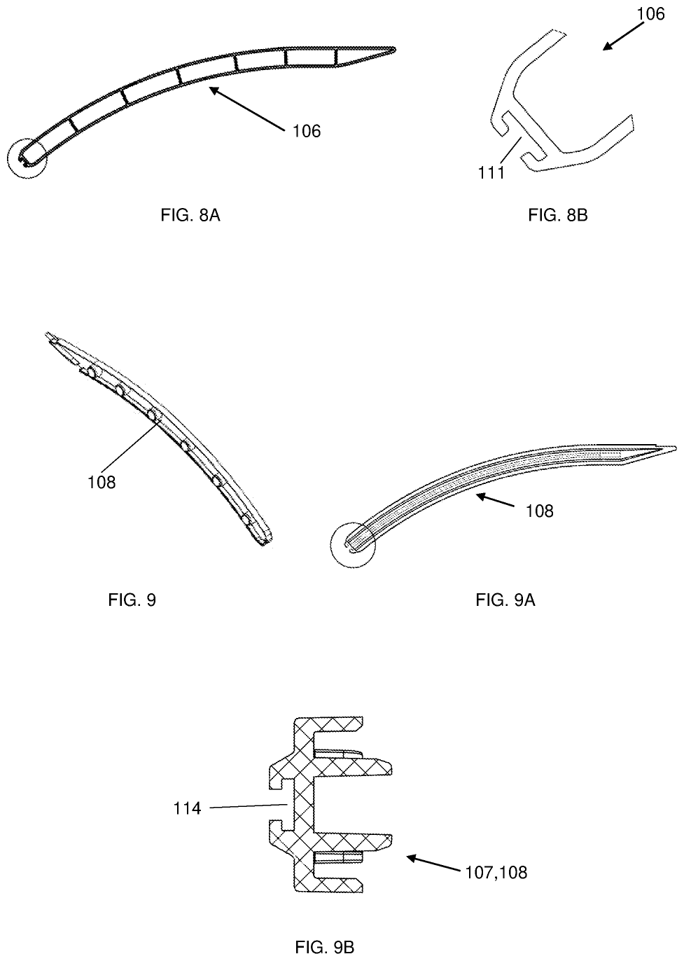

The flush mount sidewall inlet 117 includes a frame assembly 101 connected to a blade assembly 125 via a hinge 103. The frame assembly 101 includes a top frame 100, a bottom frame 102, and two frame endcaps 104,105, as shown in FIG. 3. The blade assembly 125 includes a curved louver blade 106 and two louver blade endcaps 107,108 as shown in FIG. 8.

The flush mount sidewall inlet 117 is not installed into the rough opening of the building, but rather is installed flush to the wall on the inside of the rough opening and then opens into the building. In one embodiment, no part of the flush mount sidewall inlet 117 crosses the interior planar surface 133 of the building wall to fit into the rough opening of the building.

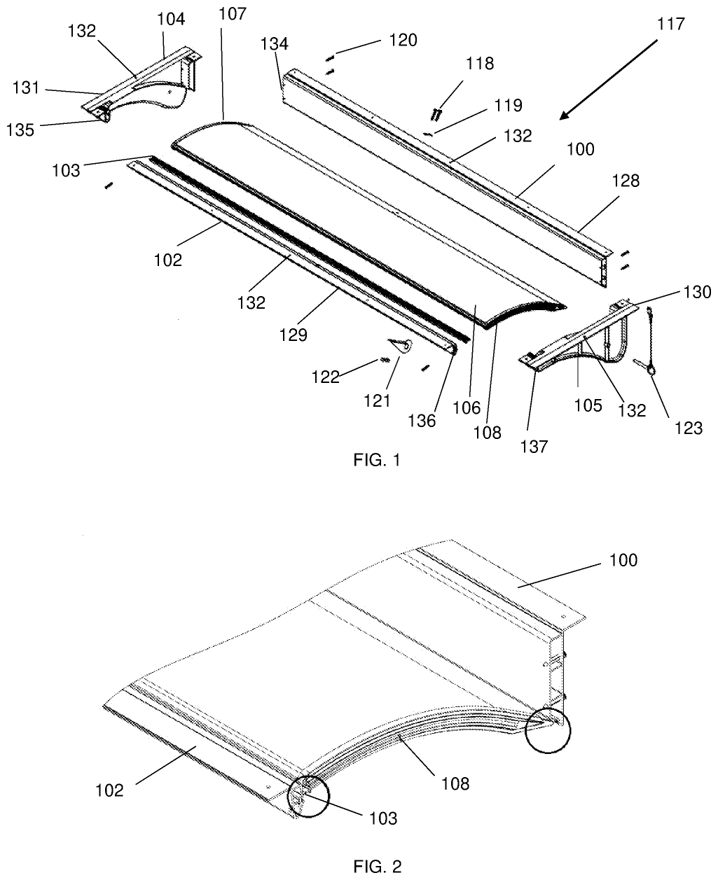

At least one chosen from the top frame 100, bottom frame 102, and two frame endcaps 104, 105 may include a flush mount flange 128, 129, 130, 131 extending from a base frame portion 134, 135, 136, 137 of the at least one chosen from the top frame 100, the bottom frame 102, and the frame endcaps 104, 105 for mounting the flush mount sidewall inlet 117 to an inside planar surface 133 of the building. The flush mount flange 128, 129, 130, 131 is at a portion of the frame assembly 101 closest to the sidewall of the building. As seen in FIG. 1, the flush mount flange 128, 129, 130, 131 may span the length of the at least one chosen from the top frame 100, bottom frame 102, and two frame endcaps 104, 105. In one embodiment, the flush mount flange 128, 129, 130, 131 is a tab which does not span the length of the at least one chosen from the top frame 100, bottom frame 102, and two frame endcaps 104, 105. The flush mount flange 128, 129, 130, 131 may be substantially parallel with and align to the inside surface 133 of the wall of the building. As shown in FIG. 1, the flush mount flange 128, 129, 130, 131 may include a connection hole 132 for attaching the flush mount sidewall inlet 117 via screw, nail, or another connector to the inside surface 133 of the wall via the flush mount flange 128, 129, 130, 131. Once the flush mount sidewall inlet 117 is attached to the inside wall of the building, the flush mount sidewall inlet 117 extends into the inside of the building as seen in FIG. 13.

Since the flush mount sidewall inlet 117 is connected to the inside surface 133 of the wall via the flush mount flange 128, 129, 130, 131 and extends inwardly into the building, the flush mount sidewall inlet 117 does not have to be the same size as the rough opening. The flush mount sidewall inlet 117 may be substantially larger than the rough opening and will still attach to the wall and perform as desired.

The design of the frame assembly 101 and the blade assembly 125 allow the flush mount sidewall inlet 117 to be customizable to fit many size variations of rough openings 115. The top frame 100, bottom frame 102, and louver blade 106 are each designed to be cut to multiple sizes of rough openings 115. In one embodiment, the hinge 103 is a continuous hinge 103 which is also designed to be cut to size based on the size of the rough opening 115. When cutting to size, the frame assembly's 101 top frame 100 and bottom frame 102 are measured and cut. The louver blade 106 is measured and cut. Then louver blade endcaps 107,108 are connected into place on the louver blade 106, and may be connected into place with an adhesive. In one embodiment a continuous hinge 103 which spans a length of the bottom frame 102 is cut to size. The hinge 103 is connected to the bottom frame 102. After which, the hinge 103 is connected to the leading edge of the louver blade 106 and louver blade endcaps 107,108. The frame endcaps 104,105 are then connected to the top frame 100 and the bottom frame 102, In one embodiment the frame endcaps 104, 105 are connected to the top frame 100 and the bottom frame 102 with an adhesive and plastic nail 120. The flush mount sidewall inlet 117 is then ready to be installed over the rough opening 115. FIG. 3 is a fully assembled, front view of a flush mount sidewall inlet 117 as it would appear inside the building after installation.

The flush mount sidewall inlet 117 shown in FIG. 3 is comprised of a top frame 100, a bottom frame 102, a continuous hinge 103, frame endcaps 104,105, a louver blade 106, louver blade endcaps 107,108, a quick release pin 123, which may function as a manual shut off to prevent the louver blade 106 from opening, and a bracket 121 for manually opening and closing the flush mount sidewall inlet 117. The flush mount sidewall inlet 117 can be fitted to be installed over a buildings rough opening 115 of various sizes for ventilation purposes on the sidewall of an interior room. As well known to those skilled in the art, a flush mount sidewall inlet 117 is typically combined with an actuator, not shown, and an exhaust fan, not shown, which when on, the negative pressure caused by the fan opens the flush mount sidewall inlet 117, cycling air from outside of the building into the interior room of the building through the flush mount sidewall inlet 117.

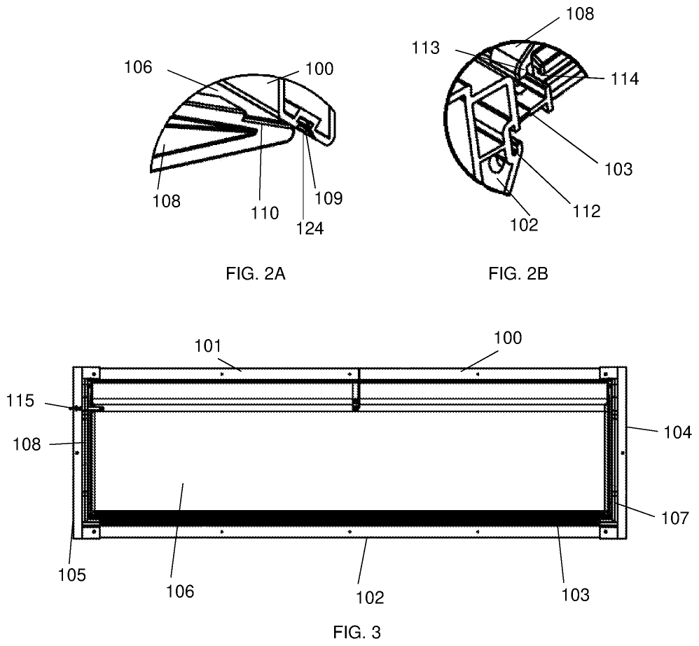

FIG. 2 shows an assembled flush mount sidewall inlet 117 without the left frame endcap 105 from the back of the flush mount sidewall inlet 117 when in a closed position. In this view it can be seen how the louver blade 106, the blade endcap 108, the continuous hinge 103, the bottom frame 102, and the top frame 100 connect. The louver blade 106 and louver blade endcap 108 connect at its leading edge to a continuous hinge 103 which pivots the curved louver blade 106 to an open and a closed position with the lower hinge T of the continuous hinge 103 connecting to the bottom profile 102. FIG. 2A is an enlarged view of the top frame 100 where the trailing edge of the louver blade 106 and louver blade endcap 108 connect to the top frame 100. FIG. 2 shows a recess 110 at the trailing edge of the louver blade endcap 108 to allow for a better seal, reducing the light and air leakage from the top frame 100 to the louver blade 106. The trailing edge of the louver blade 106 and the louver blade endcap 108 may include rounded edges as can be seen in this enlarged view. The rounded edges help to facilitate proper airflow into the building when the flush mount sidewall inlet 117 is in an opened position. The aerodynamic curved louver blade 106 and the flush mount sidewall inlet 117 directs fresh air from the outside, through the flush mount sidewall inlet 117 and along the ceiling to the peak for maximum air mixing. FIG. 2A also shows a weatherstrip groove 109 on the top frame 100 where weatherstrip material 124 may be installed into the weatherstrip groove 109 creating a better seal, thus reducing light and air leakage.

FIG. 2B is an enlarged view of the connection between the louver blade 106, blade endcap 108, the continuous hinge 103 and the bottom frame 102. This view shows a bottom frame hinge groove 112 in the bottom frame 102 and a hinge groove 113 in the leading edge of the blade endcap 108 where the continuous hinge 103 goes into the hinge grooves 112, 113 to connect the leading edge of the louver blade 106 and louver blade endcap 108 with the bottom frame 102. The hinge grooves 112, 113 may each be T-shaped hinge grooves. This enlarged view also includes a weatherstrip groove 114, where weatherstrip material 124 may be inserted for reducing light and air leakage.

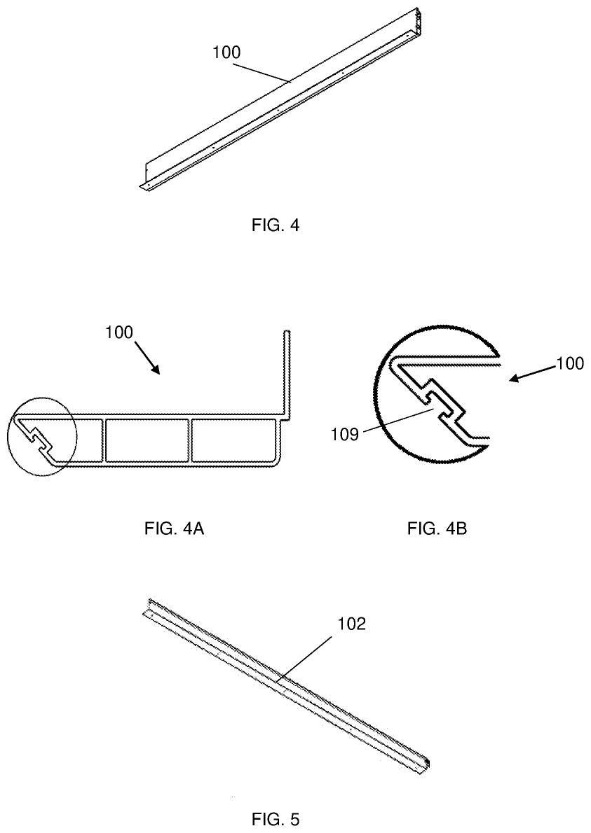

FIG. 4 shows a standard top frame 100 profile view as seen from the rear of the flush mount sidewall inlet 117. FIG. 4A shows the right-side view of the top frame 100 as it would be installed flush against the wall with the top frame 100 extending into the interior of the room to the left. FIG. 4B shows an expanded view of the left side of the top frame 100 from FIG. 4A, and shows a weatherstrip groove 109 for applying weatherstrip material 124 at an outer part of the top frame 100 on the left side to reduce light and air leakage into the building when the flush mount sidewall inlet 117 is in a closed position.

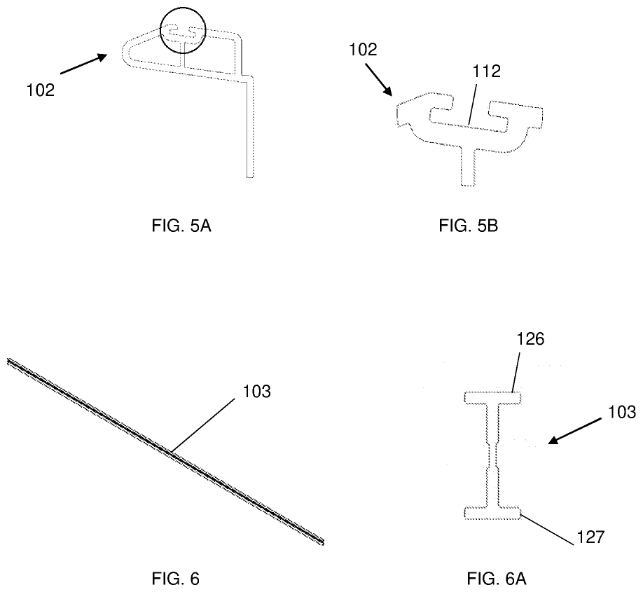

FIG. 5 shows the bottom frame 102 as viewed from the bottom and front of the flush mount sidewall inlet 117. FIG. 5A is a side view of the bottom frame 102 as viewed from the right side of the frame. When the flush mount sidewall inlet 117 is mounted, a right portion of this side view would be mounted flush to the wall, with the bottom frame 102 extending to the interior of the room to the left side. FIG. 5B is an enlarged view of bottom frame hinge groove 112 in FIG. 5A. A continuous hinge 103 is installed with the lower T portion 127 of the continuous hinge 103 fitting into the bottom frame hinge groove 112.

The hinge 103 may include any type of hinge, such as a ball bearing hinge, an overlay hinge, an offset hinge, a strap hinge and a continuous hinge. In a preferred embodiment, the hinge 103 is a continuous hinge 103, which may be at least one chosen from a metal hinge, a plastic hinge, a metal dowel, a plastic dowel, or a wooden dowel. FIG. 6 is a perspective view of a continuous hinge 103. The continuous hinge 103 includes upper T portion 126 and a lower T portion 127. The continuous hinge 103 provides a superior connection and prevents the greatest amount of air and light leakage compared to other hinges used. The lower T portion 127 of the continuous hinge 103 as seen in FIG. 6A is installed into the bottom frame hinge groove 112 and the upper T portion 126 of the continuous hinge 103 is installed in the leading edge of the louver blade 106 into the louver blade hinge groove 111 and the leading edge of the louver blade endcaps 107,108 hinge groove 113. The design with the continuous hinge 103 into the bottom frame 102 and the leading edge of the louver blade 106 and the leading edge of the louver blade endcaps 107,108 is to prevent the greatest amount of light and air leakage when the flush mount sidewall inlet 117 is in either a closed or an open position.

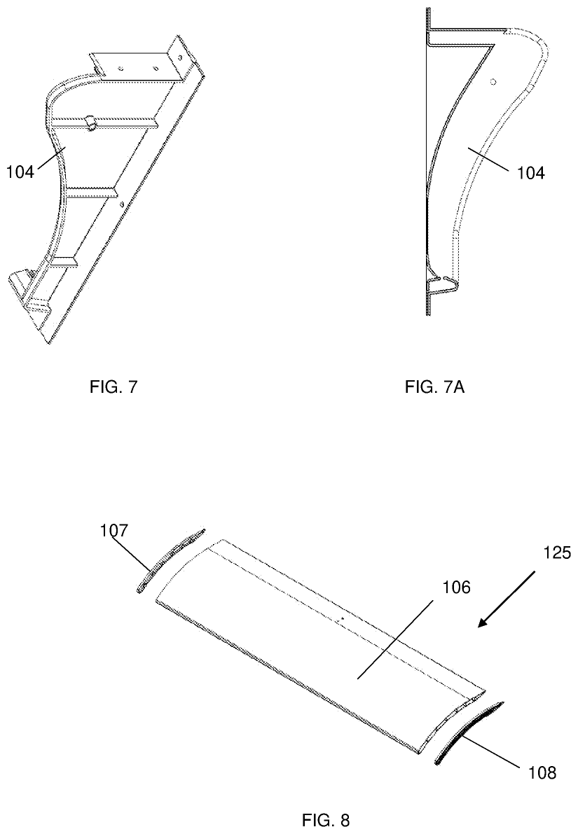

FIG. 7 shows a perspective view of a right frame endcap 004 as it would be viewed from the front of the flush mount sidewall inlet 117. The right frame endcap 104 is also seen in FIG. 7A as viewed from the inside of the right frame endcap 104. The frame endcaps 104,105 are fitted over the top frame 100 and bottom frame 102 creating a customizable length that can be fitted over any size rough opening 115. The preferred method for assembling the frame assembly 101 is by connecting the top frame 100 and bottom frame 102 to the frame endcaps 104,105 using an adhesive and/or plastic nails 120.

FIG. 8 shows the blade assembly 125, including the louver blade 106, and the louver blade endcaps 107,108. The louver blade endcaps 107,108 allow for the louver blade 106 to be customizable to multiple sizes, fitting many variations of rough openings 115. The louver blade 106 as seen in FIG. 8A shows the inside of a louver blade 106 once it is cut to size. The louver blade 106 includes stabilizing joints to help maintain the louver blades 106 structure when cut and when in operation increasing the louver blades 106 durability. This allows the louver blade to maintain its structural integrity when it is cut to size.

The FIG. 8B shows an enlarged view of the leading edge of the louver blade 106 and the louver blade hinge groove 111, where the preferred method of a continuous hinge 103 is inserted. Once the louver blade 106 is cut to size, the louver blade endcaps 107,108 are connected along with an adhesive to the louver blade 106 ends. The louver blade endcap 108 as seen in FIG. 9 is of a left louver blade endcap 108, as viewed from the inside of the louver blade endcap 108. This side is attached to the louver blade 106. FIG. 9A is a left louver blade endcap 108 as viewed from the outside, this is the view from the side of the louver blade 106 after the louver blade endcap 108 is attached. FIG. 9B is an enlarged view of the louver blade endcap 108 as it is viewed from the left side of the image, as seen from the outside of the endcap with the right side of the endcap attaching to the louver blade 106. In FIG. 9B the weatherstrip groove 114 can be seen on the outside of the louver blade endcaps 107,108. Connecting the louver blade endcaps 107,108 to the louver blade 106 creates a seal preventing the darkling beetles getting to the insulation on the inside of the louver blade 106. The louver blade endcaps 107,108 also have a weatherstrip groove 114 for weatherstrip material to be inserted to prevent air and light leakage into the building.

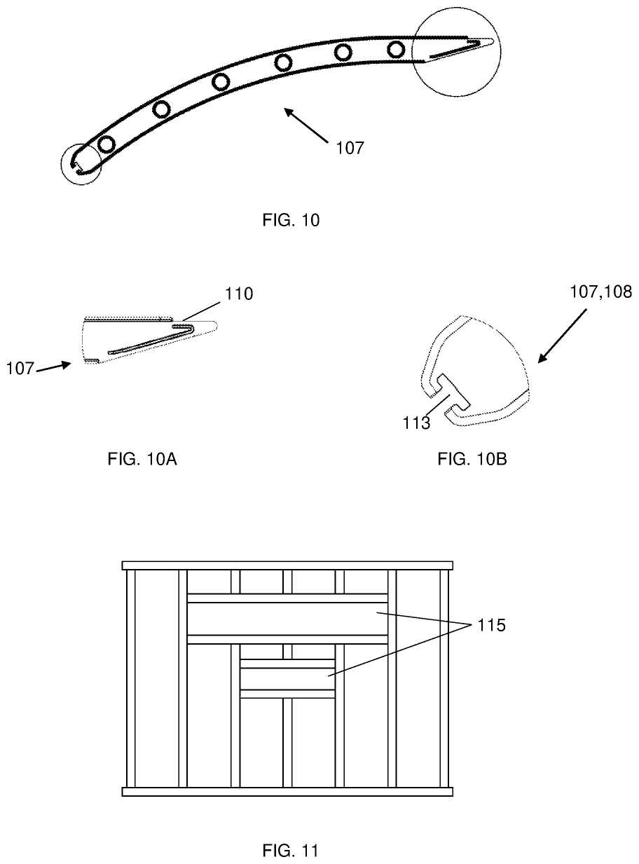

FIG. 10 shows a right louver blade endcap 107 as it would be viewed looking at the inside of the endcap. This side would be attached to the louver blade 106 when connecting the louver blade endcap 107 to the louver blade with an adhesive. FIG. 10A is an enlarged view of the trailing edge of the right louver blade endcap 107. In this enlarged view, it can be seen that the right louver blade endcap 107 has a recessed 110 area of the louver blade endcap 107 which allows for a better seal when the flush mount sidewall inlet 117 is in a closed position and the trailing edges of the louver blade endcaps 107,108 and the trailing edge of the louver blade 106 are resting against the top frame 100. This design allows the seal of the flush mount sidewall inlet 117 to have less air and light leakage when in a closed position between the top frame 100 and trailing edge of the blade assembly 125. In the enlarged view of the right louver blade endcap 107 in FIG. 10B, the leading edge of the endcap is shown. On the leading edges of the louver blade endcaps 107,108 the continuous hinge groove 113 can be seen. This is where the continuous hinge 103 slides into the louver blade hinge groove 111 allowing for the continuous hinge 103 to be installed when the blade assembly 125 is fully assembled and ready to be attached to the bottom frame 102.

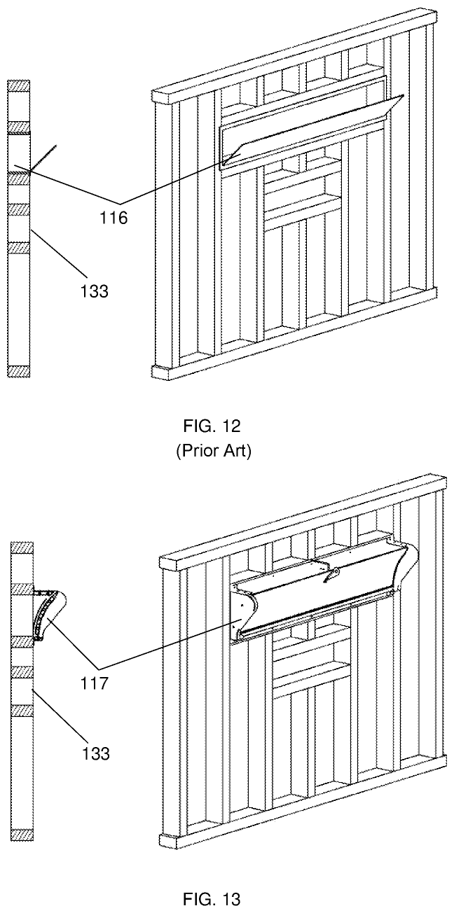

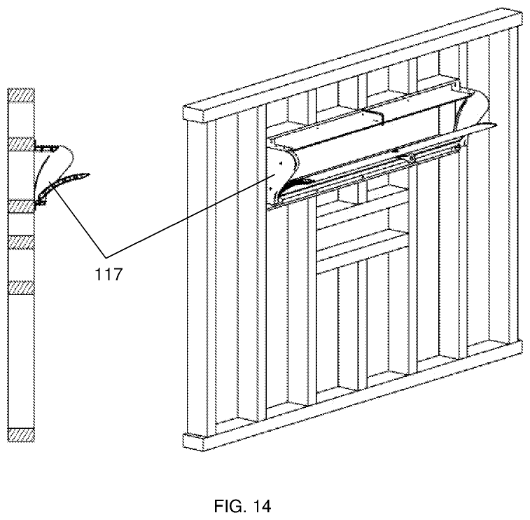

FIG. 11 is an example of rough openings 115 in a wall. This example illustrates rough openings 115 can come in the form of many size variations. The design of the flush mount sidewall inlet 117 is customizable to fit many of these variations. FIG. 12 further illustrates how prior technology 116 is recessed into a rough opening 115 rather than located flush to the interior planar surface 133 of the building wall, as well as how the airflow would come into the room through the flush mount sidewall inlet 117 as seen from this side view image and in a 3D perspective view. FIG. 13 shows a side view image and a 3D perspective view of a flush mount sidewall inlet 117 over a rough opening 115 of a wall. The view helps to illustrate how no part of the flush mount sidewall inlet 117 is recessed into the rough opening 115 and is designed to fit over interior at the rough opening 115 and attached to the sidewall. FIG. 14 illustrates how the flush mount sidewall inlet 117 would look when the flush mount sidewall inlet 117 is open allowing air to flow into the room.

FIG. 12 further illustrates how air flows into a building from prior technology 116, flowing into the room bouncing off the baffle straight up into the air as well as around the sides of the prior technology inlet 116 to the sidewalls and downward creating improper air mixture and airflow into the room. FIG. 14 shows how air flows into a building using our new technology of the flush mount sidewall inlet 117 with the curved blade 106 design as well as the curved design of the top frame 100, the frame endcaps 104,105, and the continuous hinge 103 all allow for less air leakage and proper flow of air in a more direct path to the center of the building. The design of the frame endcaps 104,105 help to prevent air leakage on the sides of the flush mount sidewall inlet 117 creating a stronger airflow pattern better able to reach the center of the building. The airflow from the leading edge to the trailing edge of the louver blade 106 and the curved ends of the top frame 100 and frame endcaps 104,105 create a more direct flow to the center of the building. These designs create a more uniform and proper mixture of air into the building.

As can be seen in FIGS. 1, 4A, 5A, 7, 8, 8A, the top frame 100, bottom frame 102, endcaps 104,105 and the curved louver blade 106 are designed to be hollow allowing for insulation to be injected into the hollow openings creating a fully insulated flush mount sidewall inlet 117. The fully insulated louver blade 106 and inlet design will minimize sweating in cold climates and create a more stable moisture level inside of the building. The flush mount sidewall inlet 117 may be composed of any material, but is preferably composed of a plastic material, which is resistant to corrosion and bug infestations like the darkling beetle, allowing for the flush mount sidewall inlet 117 to have a longer lifespan.

The optimal design of the flush mount sidewall inlet 117 is to be composed of a plastic material, with a fully insulated louver blade 106, a fully insulated top frame 100, a fully insulated bottom frame 102, fully insulated frame endcap 104,105, a continuous hinge 103 connecting the bottom frame 102 with the blade assembly 125, which can be custom fitted to be mounted flush over rough openings 115 of various sizes to the interior of a building. This optimal design has the top frame 100, bottom frame 102, and louver blade 106 cut to the custom size required. Then, the louver blade endcaps 107,108 and louver blade 106 are connected with an adhesive. Weatherstrip material may be inserted into each of the louver blade endcaps 107,108 into the weatherstrip grooves 114. The continuous hinge 103 upper T is then inserted into the hinge groove 113 of the leading edge of the louver blade endcaps 107,108 and into the louver blade hinge groove 111 of the leading edge of the louver blade 106. The lower T of the continuous hinge 103 is then inserted into the bottom frame hinge groove 112 of the bottom frame 102. The bottom frame 102 may be then connected into place on one of the frame endcaps 104,105 using various methods, including by connecting the two together using plastic nails 120 and an adhesive. The top frame 100 is then connected to the same frame endcaps 104,105 as the bottom frame 102, using various methods, including using plastic nails 120 and an adhesive. A weatherstrip material 124 is then placed into the weatherstrip groove 109 on the top frame and is cut to length. The final frame endcap 104,105 is then connected to the bottom frame 102 and the top frame 100 using various methods, including using plastic nails 120 and an adhesive. The bracket 121 is then installed onto the louver blade 106 using screws 118, washers 119, and locknuts 122 to hold the bracket 121 in place for convenient manual opening and closing of the inlet louver blade 106. A ring grip quick release 123 may also be installed to manually lock the door from opening if desired. The flush mount sidewall inlet 117 is then fully assembled and ready to be installed over a rough opening 115 on a sidewall. The flush mount sidewall inlet 117 is designed to be screwed onto the sidewall using predrilled holes on the top frame 100, bottom frame 102, and frame endcaps 104,105 and screwed directly onto the sidewall. A caulk-like material may then be used to seal the flush mount sidewall inlet 117 to the wall and become airtight with no air leakage between the wall and the flush mount sidewall inlet 117.

Any of the top frame 100, bottom frame 102, louver blade 106, and continuous hinge 103 may include at least one of measurement markings, indentations, perforations, and non-uniform thickness at various lengths for ease of measuring and cutting. The louver blade 106 may include brush borders on each end.

Having thus described the invention in connection with the preferred embodiments thereof, it will be evident to those skilled in the art that various revisions can be made to this preferred embodiment described herein without departing from the spirit and scope of the invention.

Embodiments of the invention may include one or more of the following additional features, separately or in combination, although they are not the preferred embodiment of the invention. Those features include a plastic material for the top frame 100, bottom frame 102, endcaps 107,108, and louver 106, or a non-plastic material such as galvanized steel or a material composed of a hard rubber, could form the entirety of the flush mount sidewall inlet 117 or a portion of the flush mount sidewall inlet 117. The frame assembly 101 and the blade assembly 125 are all preferably foam filled with insulation, though the insulation could be made of another material filled with a non-foam insulation. The frame assembly 101 and blade assembly 125 could be left uninsulated or composed of a solid material with no hollow openings. The hinges could be designed to be placed on the outside of the louver blade 106 and attached to both the louver blade 106 and the bottom profile 102 with a spring type mechanism which would open and close the louver blade 106 when activated. The frame assembly 101 of the flush mount sidewall inlet 117 could be fitted to not be screwed onto the wall and just stuck to the wall over a rough opening 115 with an adhesive, a glue, or a caulk like substance. These additional features either in combination or separately are not the preferred embodiments of the invention, although, all of which are within the same spirit and scope of the invention of our flush mount sidewall inlet 117.

1. An air inlet for providing airflow between an exterior of a building and an interior of the building through a rough opening of the building, comprising:
a frame assembly including a top frame, a bottom frame, and two frame endcaps;
a blade assembly including a louver blade and two louver blade endcaps;
a hinge which connects the blade assembly to the bottom frame of the frame assembly; and
wherein when in a closed position, a trailing edge of the blade assembly seals against the frame assembly to prevent light and airflow, and when in an open position, air enters through the frame assembly and is directed by a leading edge of the blade assembly into the building.

2. The air inlet of claim 1, wherein the top frame includes a cut top frame in which the top frame fits a measurement of the rough opening of the building, wherein the bottom frame includes a cut bottom frame in which the bottom frame fits the measurement of the rough opening of the building, and wherein the two frame endcaps are connected to the cut top frame and the cut bottom frame.

3. The air inlet of claim 2, wherein at least one chosen from the cut top frame and the cut bottom frame have been cut to fit a measurement of the rough opening.

4. The air inlet of claim 1, wherein the louver blade includes a cut louver blade in which the louver blade is cut to fit a measurement of the rough opening of the building, and wherein the two louver blade endcaps are connected to the cut louver blade.

5. The air inlet of claim 1, wherein the hinge includes a cut hinge in which the hinge is cut to fit a measurement of the rough opening of the building, and wherein the cut hinge connects the leading edge of the blade assembly to the bottom frame of the frame assembly.

6. The air inlet of claim 1, wherein at least one of the top frame, the bottom frame, the louver blade, and the hinge are composed of at least one chosen from plastic, polymer, composite plastic material, or nonplastic material, which is easily cut with a blade.

7. The air inlet of claim 1, wherein the air inlet is completely composed of non-plastic material.

8. The air inlet of claim 6, wherein the air inlet is composed of rubber or galvanized steel.

9. The air inlet of claim 1, wherein at least one of the top frame, the bottom frame, the louver blade, and the hinge include at least one of measurement markings, indentations, perforations, and non-uniform thickness at various lengths.

10. The air inlet of claim 1, wherein at least one chosen from the frame assembly and the blade assembly include hollow portions, which are at least partially hollow.

11. The air inlet of claim 10, wherein the hollow portions are at least partially filled with insulation.

12. The air inlet of claim 1, wherein the at least one of the top frame, bottom frame, and the louver blade endcaps includes a recessed groove.

13. The air inlet of claim 12, wherein a weatherstrip material is installed in the recessed groove.

14. The air inlet of claim 1, wherein the hinge is a continuous hinge extending from one of the two frame endcaps to the other of the two frame endcaps, wherein the continuous hinge includes at least one of an upper T portion and a lower T portion, and wherein at least one leading edge of the louver blade and the bottom frame includes a hinge groove for receiving the at least one of the upper T portion and the lower T portion of the continuous hinge.

15. The air inlet of claim 1, wherein the blade assembly includes a trailing edge with a recess, and wherein when in a closed position, the frame assembly fits in the recess of the blade assembly to prevent light and airflow through the air inlet.

16. The air inlet of claim 1, wherein the frame endcaps include side walls adjacent to the louver blade to prevent air leakage at various positions of the louver blade.

17. The air inlet of claim 1, wherein at least one of the louver blade, the top frame, the frame endcaps, and the hinge is at least partially curved to maximize air flow.

18. The air inlet of claim 1, wherein at least one of the top frame, the bottom frame, and the frame endcaps includes a flush mount flange and a base frame portion, and wherein the flush mount flange extends from the base frame portion for mounting the air inlet to an interior of the building, and wherein the air inlet extends into the interior of the building.

19. The air inlet of claim 1, wherein no part of the air inlet is located within interior planar surface of a sidewall of the building.

20. The air inlet of claim 1, wherein the air inlet is larger than the rough opening.
